(19) United States
(12) Patent Application Publication
(10) Pub. No.: US 2005/0132661 A1
(43) Pub. Date: Jun. 23, 2005

(54) Fastening assembly of a foil-coated vehicle glass pane and method of making same

(76) Inventors: Heinz Buerklen, Wildberg (DE); Hermann Schneider, Aidlingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/998,157

(22) Filed: Nov. 29, 2004

(30) Foreign Application Priority Data
Nov. 29, 2003 (DE) 103 55 896.9

(51) Int. Cl. E06B 3/26

(52) U.S. Cl. 52/202

(57) ABSTRACT

A vehicle glass pane which is coated with a foil, is fastened a vehicle body opening edge. The glass pane has a frameless construction and is glued onto the opening edge by its side coated by a foil. In the gluing area, for a direct glued connection between an uncoated area of the glass pane and the opening edge, the glass pane is coated by the foil only in areas.

### BACKGROUND AND SUMMARY OF THE INVENTION

This application claims the priority of German Application No. 103 55 896.9 filed Nov. 29, 2003, the disclosure of which is expressly incorporated by reference herein.

The invention relates to a fastening of a foil-coated vehicle glass pane on an opening edge of a vehicle body.

Glass panes which are coated with a clearly transparent foil toward the vehicle interior are considered to be cost-effective alternatives to laminated glass panes. In this case, the foil of the coated pane has the purpose of avoiding the penetration of glass splinters into the vehicle interior in the event of a breakage of a single-layer safety glass. In order to be able to achieve this object, the foil has to be firmly connected on the pane edges with the corresponding opening edge of the vehicle body.

A method of fastening such a foil-coated vehicle glass pane is known from German Patent Document DE 101 51 156 A1 (corresponding U.S. 2004/0183342). The pane is framed there in an edge foamed on by means of polyurethane, in which edge fastening devices are provided for fastening the framed glass pane to an opening of a vehicle body. The area of the foil of the pane which projects into the area of the polyurethane edge is provided with recesses closed on the circumference side, so that the polyurethane foam can engage as an anchoring in a detachment-preventing manner in the foil recesses.

The invention relates to the problem of producing an easily producible fastening of a foil-coated glass pane on an opening edge of a vehicle body, in the case of which the foil is provided with a particularly high retention force, that is, a protection against a detachment, in the event of a glass breakage.

This problem is basically solved according to certain preferred embodiments of the invention by providing a fastening assembly of a foil-coated vehicle glass pane on an opening edge of a vehicle body, wherein the glass pane has a frameless construction and is glued onto the opening edge by means of its side coated by a foil, and wherein, in the gluing area, for a direct glued connection between an uncoated area of the glass pane and the opening edge, the glass pane is coated by the foil only in areas.

Further advantageous features of preferred embodiments of the invention are described herein and in the claims.

The invention is based on the general idea of creating a glued connection of a foil-coated glass pane which is optimal with respect to adhesive bonding. According to certain preferred embodiments of the invention, the glued connection can be caused by an easily applicable adhesive bead between the glass pane and the opening edge. Since a direct contact of the adhesive with, on the one side, the opening edge and, on the other side, a glass area not coated by a foil is required for a secure glued connection of a glass pane to the opening edge of a vehicle body, the foil should only partially fill the gluing area between the pane and the opening edge. According to certain preferred embodiments of the invention, a partial filling by providing the foil in this area with circumferentially closed recesses is particularly advantageous so that these recesses provide a direct glued connection between the pane, and the opening edge. The adhesive, which penetrates through these closed openings in the foil, acts in the manner of an anchoring, which protects against a detachment, against tensile forces occurring in the foil in the event of a glass breakage and acting toward the pane center. Such tensile forces are created when the foil bends toward the vehicle interior.

Embodiments are illustrated in the drawing which will be explained in detail in the following.

Other objects, advantages and novel features of the present invention will become apparent from the following detailed description of the invention when considered in conjunction with the accompanying drawings.

### BRIEF DESCRIPTION OF THE DRAWINGS

FIG. 1 is a sectional view of a cutout of a foil-coated glass pane glued onto a vehicle body opening edge in accordance with a first preferred embodiment of the present invention;

FIG. 2 is a view of an alternative embodiment of the glass pane fastening according to FIG. 1; and

FIG. 3 is a sectional view of the glass pane fastening taken along the Plane of Line III-III in FIG. 2.

### DETAILED DESCRIPTION OF THE DRAWINGS

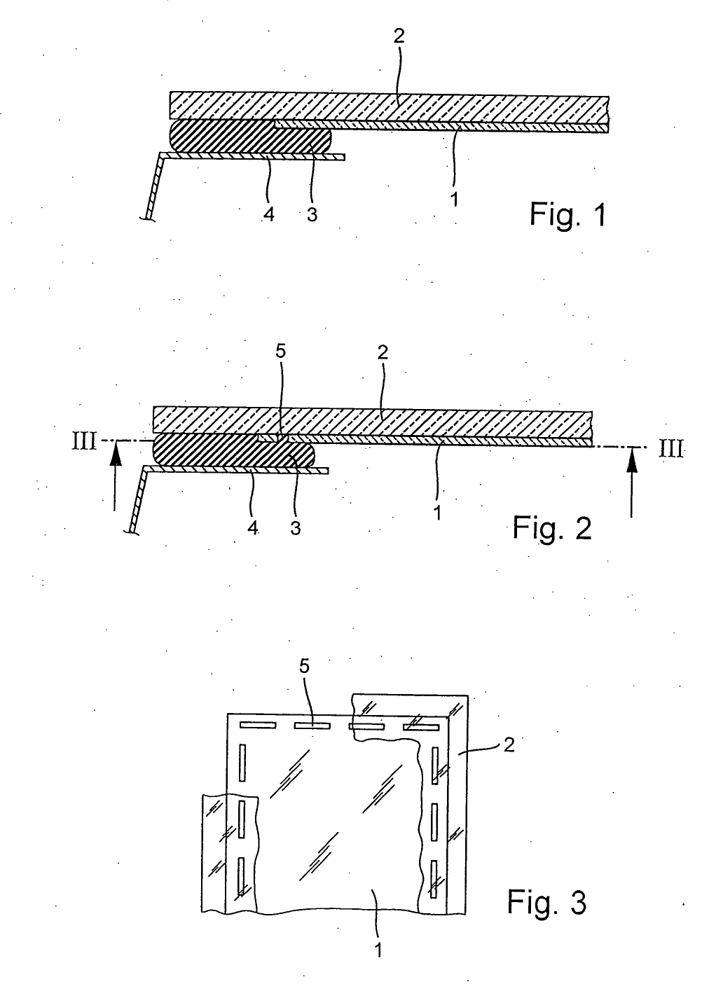

For the type of fastening according to FIG. 1, a glass pane 2 coated with a foil 1 is glued by way of a gluing area 3 constructed as an adhesive bead onto an opening edge 4 of a vehicle body. The foil projects only over a partial area into the gluing area 3 formed by the adhesive bead, so that, in the predominant portion of the gluing area 3, a direct contact of the adhesive exists with respect to a not-foil-coated area of the glass pane 2 and the opening edge 4.

In the embodiment according to FIG. 2, a plurality of circumferentially closed recesses 5 are provided in the area of the foil 1 which projects into the gluing area 3. In these recesses 5, the material of the gluing area 3 penetrates through the foil 1, whereby in these areas a direct contact of the adhesive exists with respect to an uncoated pane area and the opening edge 4.

The adhesive penetrating through the foil 1 in the recesses 5 represents an anchoring, which protects against a detachment, for the foil 1 when the latter, in the event of a breakage of the glass pane, generates tensile forces toward the interior in the edge areas.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Fastening assembly of a foil-coated vehicle glass pane on an opening edge of a vehicle body,
wherein the glass pane has a frameless construction and is glued onto the opening edge by means of its side coated by a foil, and
wherein, in the gluing area, for a direct glued connection between an uncoated area of the glass pane and the opening edge, the glass pane is coated by the foil only in areas.

2. Fastening assembly of a foil-coated vehicle glass pane according to claim 1,
wherein, in the gluing area, the foil is provided with circumferentially closed recesses, by which a particularly good anchoring, as protection against a detachment, is achieved against tensile forces caused by a breakage of the glass pane.

3. A vehicle window assembly comprising:
vehicle body opening edge structure defining a window opening adjacent a vehicle occupant space,
a single layer safety glass pane disposed to cover said window opening,
a transparent foil coating the glass pane with uncoated edge areas of the glass pane having no foil coating, said foil coating being disposed on a side of the glass pane facing the vehicle occupant space and being operable to minimize penetration of glass slivers into the vehicle occupant space in the event of breakage of the glass pane, and
adhesive forming a direct glued connection of at least some of the uncoated edge areas of the glass pane with the vehicle body opening edge structure.

4. An assembly according to claim 3, wherein the uncoated edge areas of the glass pane include circumferentially closed recesses in the foil coating, and wherein the glued connection is within the closed recesses.

5. An assembly according to claim 3, wherein the glued connection includes an adhesive bead which extends around the window opening.

6. An assembly according to claim 4, wherein the glued connection includes an adhesive bead which extends around the window opening.

7. A method of making a vehicle window assembly comprising:
providing vehicle body opening edge structure defining a window opening adjacent a vehicle occupant space,
disposing a single layer safety glass pane to cover said window opening,
providing a transparent foil coating the glass pane with uncoated edge areas of the glass pane having no foil coating, said foil coating being disposed on a side of the glass pane facing the vehicle occupant space and being operable to minimize penetration of glass slivers into the vehicle occupant space in the event of breakage of the glass pane, and
forming a direct glued connection of at least some of the uncoated edge areas of the glass pane with the vehicle body opening edge structure.

8. A method of making a vehicle window assembly according to claim 7, wherein the uncoated edge areas of the glass pane include circumferentially closed recesses in the foil coating, and wherein the glued connection is within the closed recesses.

9. A method of making a vehicle window assembly according to claim 7, wherein the glued connection includes an adhesive bead which extends around the window opening.

10. A method of making a vehicle window assembly according to claim 8, wherein the glued connection includes an adhesive bead which extends around the window opening.
